(19) United States
(12) Patent Application Publication
(10) Pub. No.: US 2014/0244526 A1
(43) Pub. Date: Aug. 28, 2014

(54) METHODS OF PRINTING FOOD LABELS FOR RESTAURANT FOOD ITEMS

(71) Applicant: NCR CORPORATION, Duluth, GA (US)

(72) Inventors: Laura Georges, Sunland, CA (US); Jerry Butler, Morristown, TN (US); Pamela S. Hill, Flowery Branch, GA (US); Steven M. Ellis, Euless, TX (US)

(73) Assignee: NCR CORPORATION, Duluth, GA (US)

(21) Appl. No.: 13/780,954

(22) Filed: Feb. 28, 2013

(51) Int. Cl. G06Q 30/00

(52) U.S. Cl. CPC G06Q 30/018
USPC 705/317

(57) ABSTRACT

A method is provided of operating a back office facility of a restaurant to provide a food safety label for labeling of at least one raw food item received for the restaurant. The method comprises receiving delivery of raw food items from a vendor, converting a purchase order associated with the received raw food items from the vendor to an invoice, and printing a food safety label based upon quantity of raw food items indicated in the invoice. Another method is provided of operating a back office facility of a restaurant to provide a food safety label for labeling of at least one prep food item by the restaurant using raw food items. Still another method is provided of operating a back office facility of a restaurant to provide a nutrition facts label for labeling of at least one prep food item by the restaurant using raw food items.

### BACKGROUND

The present application relates to food preparation in a restaurant, and is particularly directed to methods of printing food labels for restaurant food items.

Restaurants date code food items to ensure food freshness, food safety, and compliance to date labeling requirements. Date codes are typically applied to incoming food items and prepared (“prep”) food items. There are a number of drawbacks associated with known systems and methods for date coding of food items in restaurants. One drawback is that the known date coding systems and methods are standalone. Another drawback is that the known date coding systems methods are difficult to manage since they depend upon human execution. Yet another drawback is that there is no good way to audit compliance or to verify that correct dates are being used in the known date coding systems and methods. It would be desirable to provide a date coding system and method in which drawbacks of known date coding systems and methods are overcome.

### SUMMARY

In accordance with one embodiment, a method is provided of operating a back office facility of a restaurant to provide a food safety label for labeling of at least one raw food item received for the restaurant. The method comprises receiving delivery of raw food items from a vendor, converting a purchase order associated with the received raw food items from the vendor to an invoice, and printing a food safety label based upon quantity of raw food items indicated in the invoice.

In accordance with another embodiment, a method is provided of operating a back office facility of a restaurant to provide a food safety label for labeling of at least one prep food item by the restaurant using raw food items. The method comprises creating a forecast of food menu item sales for the restaurant, translating the forecast of food menu item sales into the quantities of prep items needed for a given time, printing a prep list which contains a listing of prep food items and their respective prep amounts needed, and printing a food safety label for each prep food item based upon the prep amount in the prep list.

In accordance with still another embodiment, a method is provided of operating a back office facility of a restaurant to provide a nutrition facts label for labeling of at least one prep food item by the restaurant using raw food items. The method comprises retrieving food ingredients for a prep recipe, calculating nutritional information for a prep food item using nutrition data associated with the retrieved food ingredients for the prep recipe, and printing a nutrition facts label based upon quantity of prep food items indicated in the prep recipe.

### BRIEF DESCRIPTION OF THE DRAWINGS

FIG. 1 is a schematic block diagram representation of components of a back office and a food preparation station of a restaurant.

FIG. 2 is a flow diagram depicting a method of operating components of FIG. 1 in accordance with one embodiment.

FIG. 3 is a front view of a “received” food safety label which can be provided in accordance with the flow diagram of FIG. 2.

FIG. 4 is a flow diagram depicting another method of operating components of FIG. 1 in accordance with an embodiment.

FIG. 5 is a front view of a “prep” food safety label which can be provided in accordance with the flow diagram of FIG. 4.

FIG. 6 is a front view of another “prep” food safety label which can be provided in accordance with the flow diagram of FIG. 4.

FIG. 7 is a flow diagram depicting still another method of operating components of FIG. 1 in accordance an embodiment.

FIG. 8 is a flow diagram depicting yet another method of operating components of FIG. 1 in accordance with an embodiment.

FIG. 9 is a front view of a “nutrition facts” label which can be provided in accordance with the flow diagram of FIG. 8.

### DETAILED DESCRIPTION

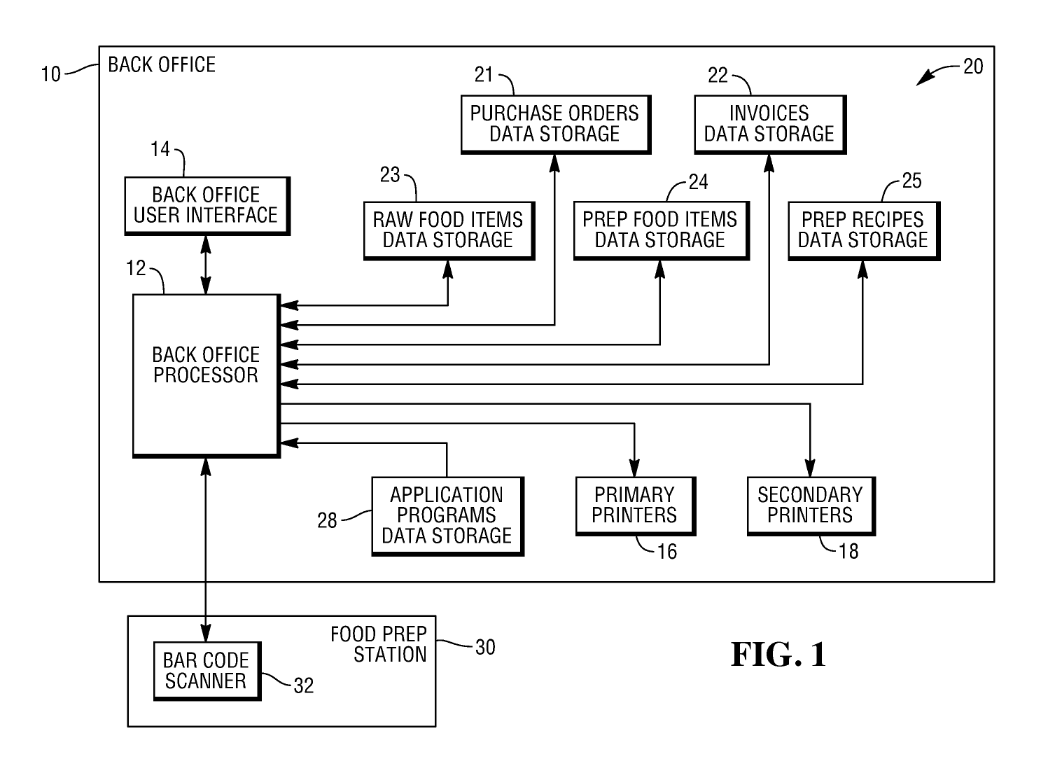

Referring to FIG. 1, a schematic block diagram representation of components of centrally-hosted restaurant back office 10 and restaurant food preparation station 30 is illustrated. Back office 10 may communicate with any number of food prep stations. However, for simplicity and purposes of explanation, only one food prep station is illustrated and designated with reference numeral “30” in FIG. 1. Food prep station 30 may include standard off-the-shelf type of barcode scanner 32.

Back office 10 includes back office electronic processor 12 which communicates with back office user interface 14. Processor 12 may comprise a computer. Back office user interface 14 comprises standard off-the-shelf type of user interface components such as keyboards, display monitors, mouse devices, and the like. Back office processor 12 communicates with multiple printers including a number of primary printers 16 and a number of secondary printers 18. Primary printers 16 and secondary printers 18 may comprise standard off-the-shelf type of printers. Primary printers 16 are default printers and may include a number of laser printers, for example. Secondary printers 18 are additional printers and may include a number of wireless belt printers, for example. As an example, primary printers 16 may be located in a manager's office and deliver reports on regular copy paper, and secondary printers 18 may be portable-type printers and deliver labels at a location where the labels are needed.

Back office processor 12 also communicates with a number of different memory data storage units 20. Data storage units 20 include purchase orders data storage unit 21, invoice data storage unit 22, raw food items data storage unit 23, prep food items data storage unit 24, and prep recipes data storage unit 25. Back office processor 12 communicates with a number of application programs stored in application programs data storage unit 28. Each application program has one or more programs of instructions tangibly embodied in the program storage medium of the application programs data storage unit 28. Back office processor 12 reads and executes computer program instructions in accordance with application programs stored in data storage unit 28 to provide methods of operating components of back office 10 to provide printed food labels described hereinbelow.

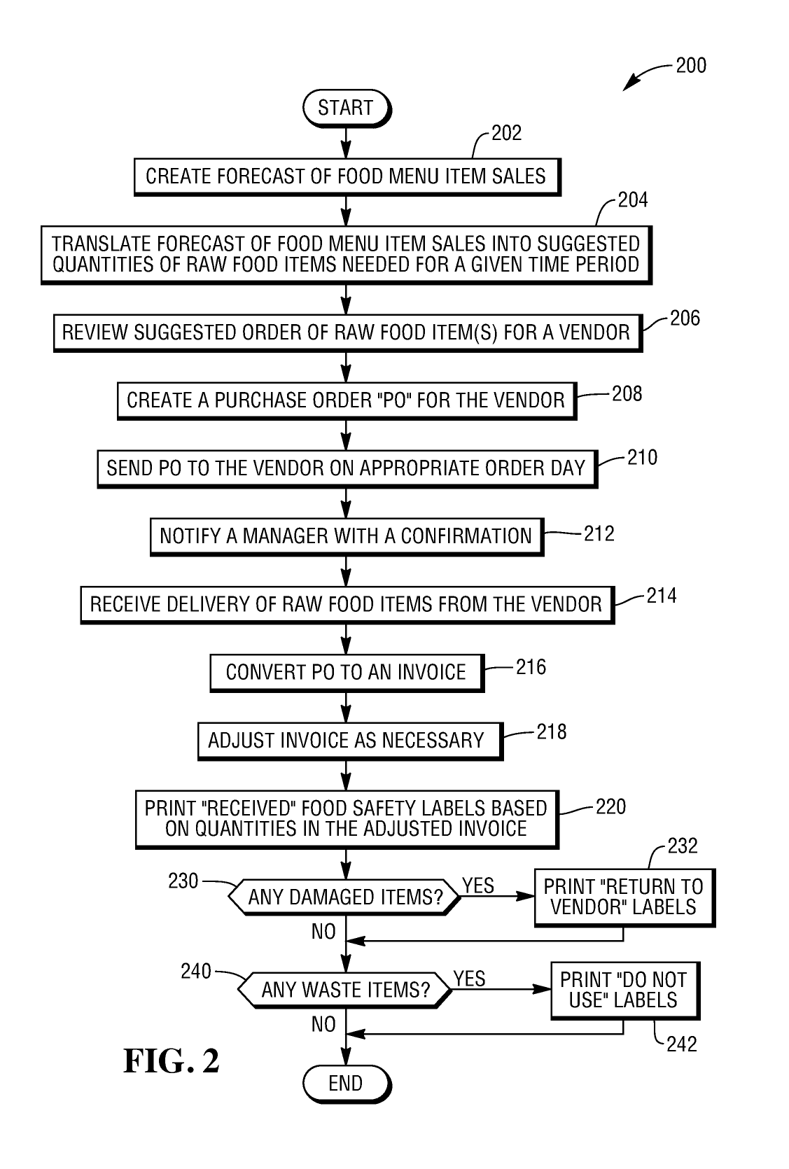

Referring to FIG. 2, flow diagram 200 depicts a method of operating components of FIG. 1 in accordance with one embodiment. More specifically, flow diagram 200 depicts a method of operating back office 12 of the restaurant (FIG. 1) to provide a food safety label for labeling of incoming raw food items received for the restaurant.

As shown in step 202, processor 12 creates a forecast of food menu item sales for the restaurant. For example, the forecast may be based on (i) actual historic sales, (ii) weighting by week of historic sales, (iii) general up-or-down adjustments, and (iv) specific up-or-down adjustments for events. Weighting and adjustments can be entered both centrally and by a store manager. The forecast of food menu item sales received in step 202 is translated into suggested quantities of raw food items needed for a given time period (step 204). Information for all raw food items is stored in raw food items data storage unit 23 (FIG. 1).

One way to translate a forecast of a raw food item into a suggested quantity is to take the required quantity, subtract out the quantity in open purchase orders (“POs”), and subtract out the quantity currently on-hand. The suggested quantity may be rounded to the next whole number, and a safety buffer may be included. The required quantity may be calculated using “forecasting”, “usage per factor”, or “par” which is based on the particular raw food item's setting. “Forecasting” may use the forecasted sales mix for the order's from and to dates. “Usage per factor” applies the raw food item's usage per to the forecasted sales for the order's from and to dates. “Par” is not cumulative, and the par amount is based on the order day. The quantity in open POs is the amount that is ordered but has not yet been received. This amount includes open POs for any vendor. The quantity currently on-hand is equal to the last inventory for the particular raw food item, plus purchases, plus transfers in, minus transfers out, and minus point-of-sale (“POS”) sales. This is the theoretical on-hand amount based on activity since the raw food item was most recently counted. This amount includes purchases and transfers in since the last count. Transfers out in sales from the POS since the last count are also applied.

A user at user interface 14 then reviews suggested order of raw food items for a particular food vendor (step 206). The user can also make updates to the suggested order if necessary. Processor 12 creates a purchase order (“PO”) for the particular vendor (step 208). PO may be in any form. For examples, PO may be a hard copy PO or an electronic PO. PO for the particular vendor is stored in purchase orders data storage unit 21 (FIG. 1). The PO is sent to the particular vendor on an appropriate order date (step 210). As shown in step 212, a manager is notified via a two-way communications link between the manager and the particular vendor with a confirmation of the PO having been sent to the particular vendor in step 210.

After the restaurant receives delivery of raw food items from the particular vendor (step 214), processor 12 converts the PO created back in step 208 to a corresponding invoice (step 216). Invoice may be in any form. For examples, invoice may be a hard copy invoice or an electronic invoice. Invoice for the particular vendor is stored in invoices data storage unit 22. Any needed adjustments to invoice of step 216 are made in step 218. Example reasons for adjustments may include damaged items or waste items. After adjustments to the invoice are made in step 218, a number of “received” food safety labels are printed based on adjusted quantities of raw food items indicated in the adjusted invoice (step 220). The “received’ food safety labels may be printed using either primary printers 16 or secondary printers 18 (FIG. 1).

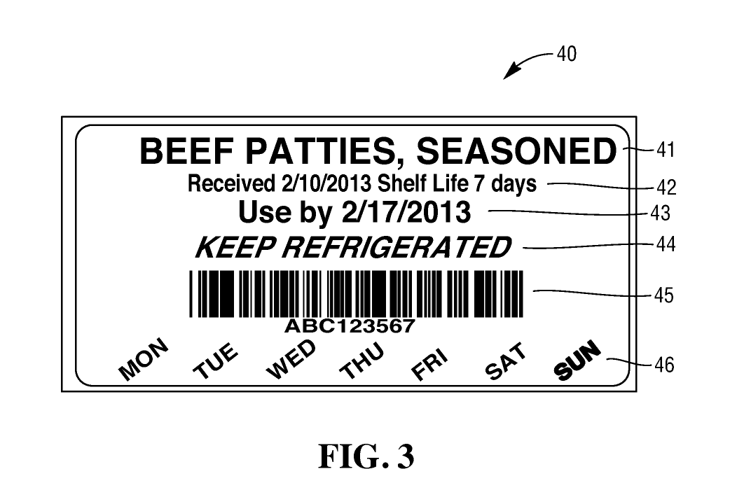

An example of a printed “received” food safety label is illustrated in FIG. 3, and is designated with reference numeral “40”. Food safety label 40 includes a number of different lines 41, 42, 43, 44, 45, 46. Line 41 indicates a description of the raw food item. Line 42 indicates the date on which the raw food item was received from the particular vendor, and indicates the shelf life of the particular raw food item. Line 43 indicates the date by which the particular raw food item should be used. Line 44 indicates an instruction that the particular raw food item should be kept in a refrigerator. It is conceivable that other configurable, handling or quality instructions (or “sensitivity” information) may be used in place of or in addition to the instruction of line 44 shown in FIG. 3. For examples, “Keep Refrigerated”, “Refrigerate After Opening”, “Maintain Temp of 160 Degrees”, or “Contains Allergens” may be used. Line 45 is a barcode which corresponds to the particular raw food item indicated in line 41. As an example, the barcode in line 45 may refer to the raw food item and the specific vendor order that it was part of, including the date and/or time received. Line 46 highlights the particular day of the week on which the particular raw food item should be used by (which in this example is a Sunday which corresponds to the date indicated in line 43). It is conceivable that the particular day may be circled instead of highlighted. It is also conceivable that non-selected days be blacked out.

Referring back to flow diagram 200 of FIG. 2, the process proceeds to step 230 in which a determination is made as to whether any damaged raw food items were received from the particular vendor. If determination in step 230 is affirmative (i.e., damaged raw food items were received), a number of “Return To Vendor” labels are printed (step 232). However, if determination in step 230 is negative (i.e., there were no damaged raw food items received), the process proceeds to step 240. In step 240, a determination is made as to whether any waste raw food items were received from the particular vendor. If determination in step 240 is affirmative (i.e., waste raw food items were received), a number of “Do Not Use” labels are printed (step 242). However, if determination in step 240 is negative (i.e., there were no waste raw food items received), the process terminates.

It should be apparent that the above-described method of flow diagram 200 has been applied to raw food items ordered from one particular food vendor. The method of flow diagram 200 is applicable to raw food item orders from other food vendors. Corresponding “received” food safety labels are printed in similar manner for food item orders from other food vendors.

It should also be apparent that “received” food safety labels are printed and applied as raw food items are received in the restaurant. This assures that correct dates are being included in individual raw food items at the point-of-entry into the restaurant. Printing “received” food safety labels at the point-of-entry increases compliance of date coding of raw food items.

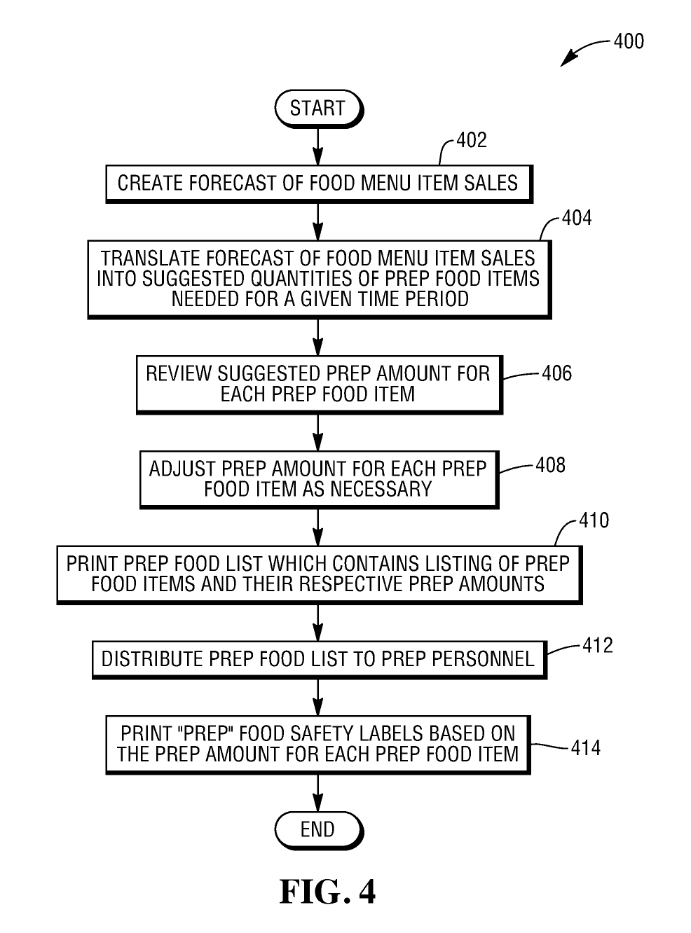

Referring to FIG. 4, flow diagram 400 depicts another method of operating components of FIG. 1 in accordance with an embodiment. More specifically, flow diagram 400 depicts a method of operating back office 12 of the restaurant (FIG. 1) to provide a food safety label for labeling of prep food items prepared by the restaurant using raw food items.

As shown in step 402, processor 12 creates a forecast of food menu item sales for the restaurant. The forecast of food menu item sales created in step 404 is translated into suggested quantities of prep food items needed for a given time period (step 404). Information for all prep food items is stored in prep food items data storage unit 24 (FIG. 1). A user at user interface 14 then reviews suggested prep amount for each prep food item (step 406). The user then adjusts prep amount for each prep food item as needed (step 408).

After adjustments to prep amounts for prep food items are made in step 408, a prep food list is printed (step 410). The prep food list contains a listing of prep food items and their respective prep amounts. The prep food list may be printed using either primary printers 16 or secondary printers 18 (FIG. 1). The prep food list is then distributed to appropriate prep personnel at food prep stations such as food prep station 30 shown in FIG. 1 (step 412). Also, after adjustments to prep amounts for prep food items are made in step 408, a number of “prep” food safety labels are printed based on the adjusted prep amount for each prep food item (step 414).

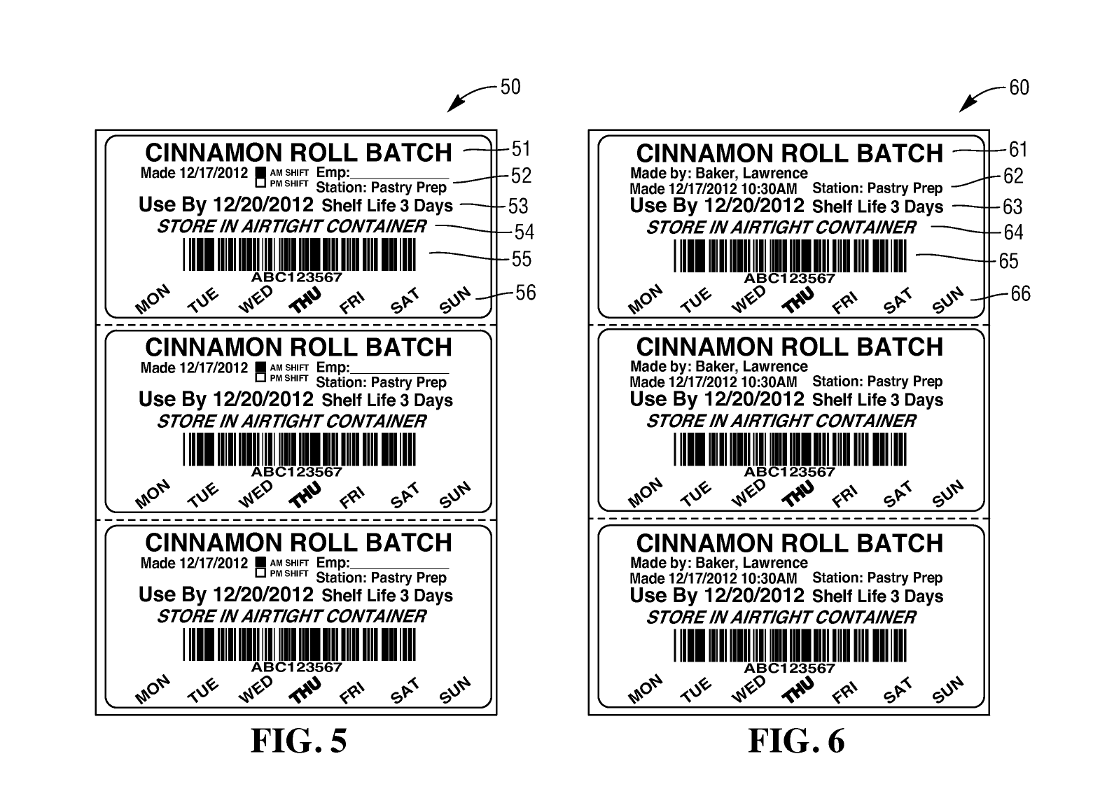

An example of a “prep” food safety label is illustrated in FIG. 5, and is designated with reference numeral “50”. Food safety label 50 shown in FIG. 5 is printed ahead of time (i.e., before preparation of the prep food item has been completed). Food safety label 50 includes a number of different lines 51, 52, 53, 54, 55, 56. Line 51 indicates a description of the prep food item. Line 52 indicates the date, time of day (i.e., morning or afternoon), and the particular food prep station at which the prep food item will be made. A blank area in line 52 is provided for the particular employee who will be making the prep food item. Line 53 indicates the date by which the particular raw food item should be used, and also indicates the shelf life of the particular prep food item. Line 54 indicates an instruction that the particular prep food item should be stored in an airtight container. It is conceivable that other configurable, handling or quality instructions (or “sensitivity” information) may be used in place of or in addition to the instruction of line 54 shown in FIG. 5. Line 55 is a barcode which corresponds to the particular prep food item indicated in line 51. As an example, the barcode in line 55 may refer to the prep food item and the specific food preparer, including the date and/or time prepared. Line 56 highlights the particular day of the week on which the particular prep food item should be used by (which in this example is a Thursday which corresponds to the date indicated in line 53). It is conceivable that the particular day may be circled instead of highlighted. It is also conceivable that non-selected days be blacked out.

Another example of a “prep” food safety label is illustrated in FIG. 6, and is designated with reference numeral “60”. Food safety label 60 shown in FIG. 6 is printed after preparation of the prep food item has been completed. Food safety label 60 includes a number of different lines 61, 62, 63, 64, 65, 66. Line 61 indicates a description of the prep food item. Line 62 indicates the date, time of day, the particular employee who made the prep food item, and the particular food prep station at which the prep food item was made. Line 63 indicates the date by which the particular prep food item should be used, and also indicates the shelf life of the particular prep food item. Line 64 indicates an instruction that the particular prep food item should be stored in an airtight container. It is conceivable that other configurable, handling or quality instructions (or “sensitivity” information) may be used in place of or in addition to the instruction of line 64 shown in FIG. 6. Line 65 is a barcode which corresponds to the particular prep food item indicated in line 61. As an example, the barcode in line 65 may refer to the prep food item and the specific food preparer, including the date and/or time prepared. Line 66 highlights the particular day of the week on which the particular prep food item should be used by (which in this example is a Thursday which corresponds to the date indicated in line 63). It is conceivable that the particular day may be circled instead of highlighted. It is also conceivable that non-selected days be blacked out.

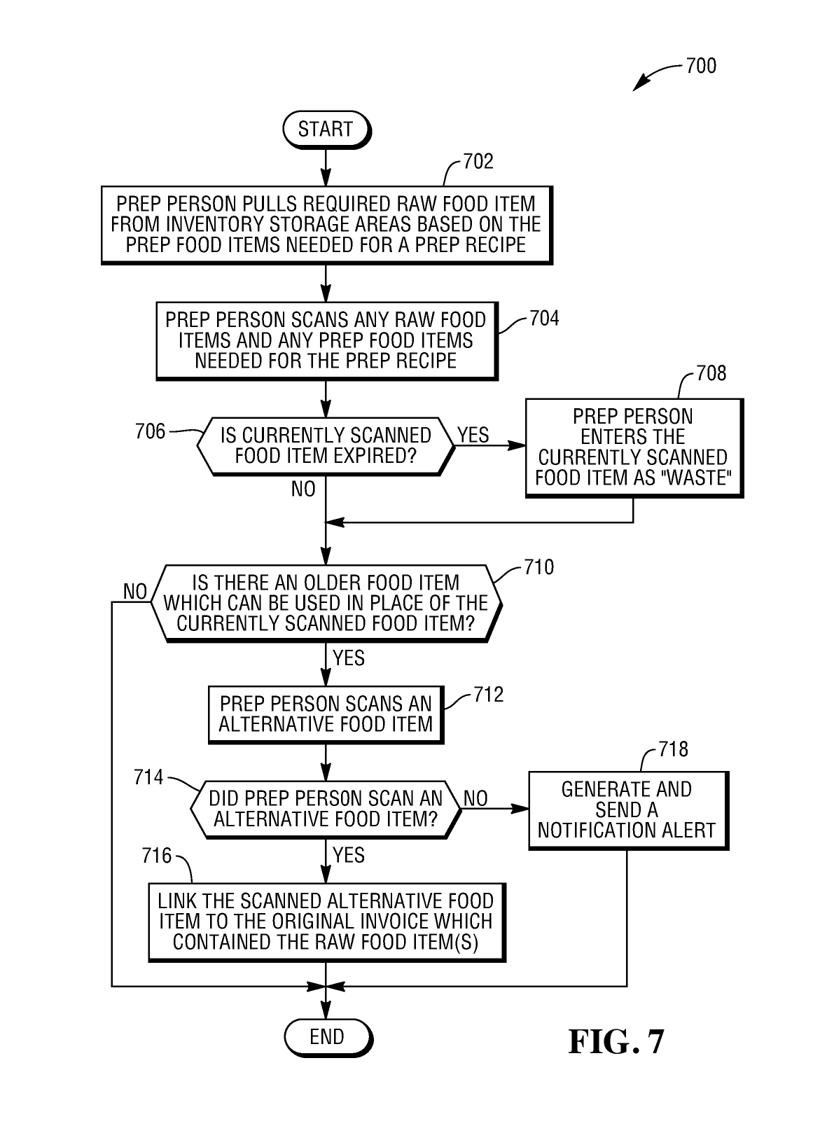

Referring to FIG. 7, flow diagram 700 depicts still another method of operating components of FIG. 1 in accordance with an embodiment. More specifically, flow diagram 700 depicts a method of operating back office 12 of the restaurant (FIG. 1) to enable a person at food prep station 30 (FIG. 1) to handle expired food items and to select an alternative food item in its place.

As shown in step 702, a prep person at prep station 30 pulls required raw food items from inventory storage areas based upon particular prep food items needed for a particular prep recipe. Information for all prep recipes is stored in prep recipes data storage unit 25 (FIG. 1). Then, as shown in step 704, the prep person scans any raw food items and any prep food items needed for the particular prep recipe.

A determination is made in step 706 as to whether the currently scanned food item (i.e., either raw food item or prep food item) has expired based on the date and/or time as indicated in the barcode of the currently scanned food item. If determination in step 706 is affirmative (i.e., the currently scanned food item has expired), the prep person enters (via barcode scanner 32 shown in FIG. 1, for example) the currently scanned food item and identifies the currently scanned food item as “waste”. The process then proceeds to step 710. However, if determination in step 706 is negative (i.e., the currently scanned food item has not expired), the process proceeds directly to step 710.

A determination is then made in step 710 as to whether there is an older food item (by looking at the date and/or time as indicated in the barcode of a food item) which can be used in place of the currently scanned food item. If determination in step 710 is negative (i.e., there are no older food items which can be used in place of the currently scanned food item), the process terminates. However, if determination in step 710 is affirmative (i.e., there is an older food item which can be used in place of the currently scanned food item), the process proceeds to step 712.

In step 712, the prep person scans an alternative food item which can be used in place of the currently scanned food item. A determination is then made in step 714 as to whether the prep person has scanned an alternative food item back in step 712. If determination in step 714 is affirmative (i.e., an alternative food item has been scanned by the prep person), the process proceeds to step 716. In step 716, the scanned alternative food item from step 712 is linked to the original invoice (see step 216 in flow diagram 200 of FIG. 2) which itemized particular raw food item(s) used in the present prep recipe.

However, if determination in step 714 is negative (i.e., an alternative food item has not been scanned by the prep person), the process proceeds to 718. In step 718, a notification alert is generated and sent to an appropriate person to notify this person that an alternative food item has not been selected when an older food item has been identified and can be used in place of the currently scanned food item. The process then terminates.

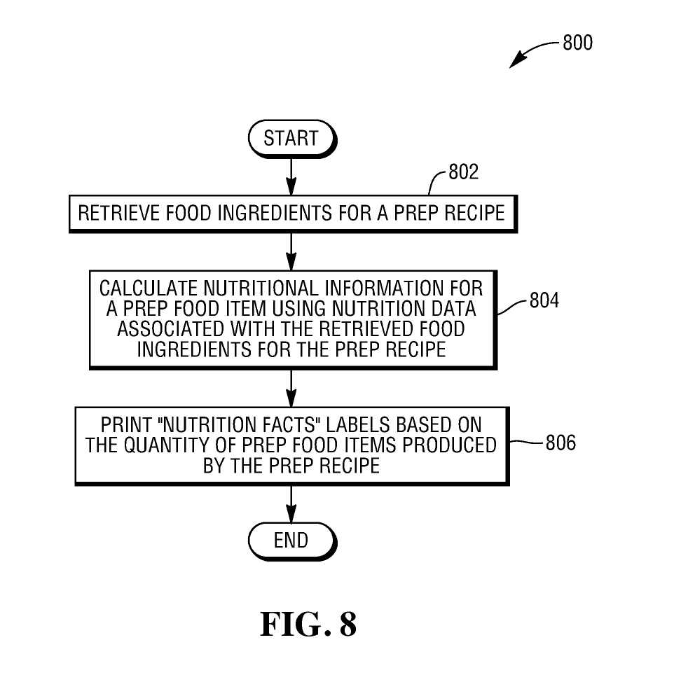

Referring to FIG. 8, flow diagram 800 depicts yet another method of operating components of FIG. 1 in accordance with an embodiment. More specifically, flow diagram 800 depicts a method of operating back office 12 of the restaurant (FIG. 1) to provide nutrition facts labels for labeling of either raw food items or prep food items in the restaurant.

As shown in step 802, food ingredients for a particular prep recipe are retrieved from prep recipes data storage unit 25 (FIG. 1). Nutritional information for the prep food item prepared from the particular prep recipe is calculated (step 804). More specifically, nutritional information for the prep food item is calculated based upon nutrition data associated with the food ingredients retrieved in step 802. Nutrition data is stored by food ingredient, and nutrition information for the prep food item is calculated based upon nutrition data of the retrieved food ingredients. This calculation of nutritional information for the prep food item is dynamic in that it can be performed “on-the-fly” or “on-demand” and in accordance with any changes in food ingredients or any changes in nutrition data associated with the food ingredients for a particular prep recipe.

As an example, if a particular prep food item (or batch of food items) was made with a lower-sodium recipe, then the calculated nutritional information would reflect that. The calculation of nutritional information could also take into account nutritional information from the raw food items, quantity used, and how the cooking method (e.g., fry vs. boil vs. bake) affects the nutritional values. Since calculations can be done “on-the-fly”, the restaurant would not need to pre-print labels in quantity for each variant of a food item. After nutrition information for the prep food item is calculated in step 804, a number of “nutrition facts” labels are printed based on the quantity of prep food items produced by the particular prep recipe (step 806).

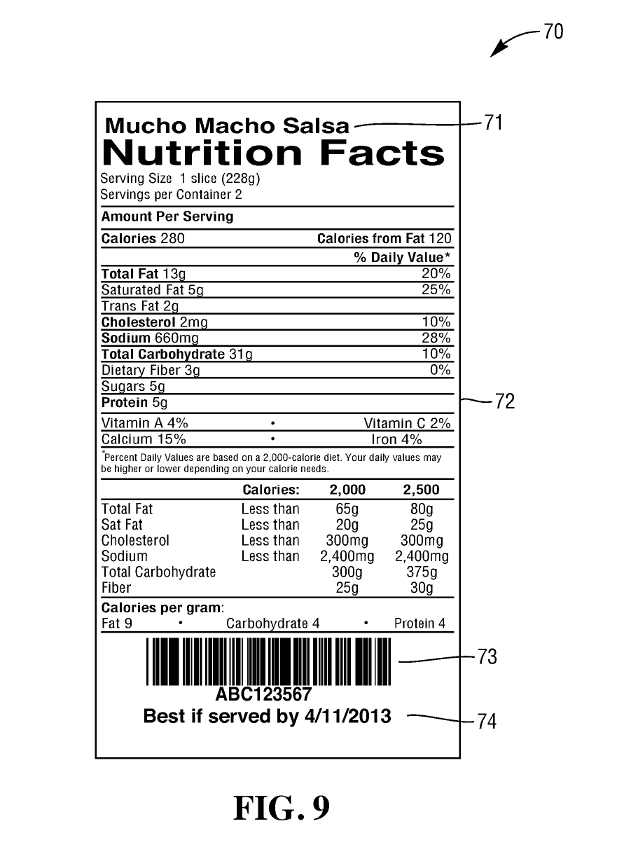

An example of a “nutrition facts” label is illustrated in FIG. 9, and is designated with reference numeral “70”. Nutrition facts label 70 includes a number of different lines 71, 72, 73, 74. Line 71 indicates a description of the prep food item, which in this example is a jar of salsa. Line 72 indicates a body of nutrition information which is arranged and printed in known standard format to provide a Food and Drug Administration (“FDA”)—standard type of label, for example. Line 73 is a barcode which corresponds to the particular prep food item indicated in line 71. As an example, the barcode in line 73 may refer to the prep food item and the specific food preparer, including the date and/or time prepared. Line 74 indicates the date by which the particular prep food item should be served or sold by (which in this example is Apr. 11, 2013).

It should be apparent that the particular printed nutrition facts label 70 shown in FIG. 9 is for a prep food item. A nutrition facts label could be printed in the same manner for a raw food item in accordance with flow diagram 800 of FIG. 8.

It should also be apparent that intent of barcodes on printed labels is for tracking a specific prep item/date and time combination. Possibilities include a number based on prep item number and date, and a sequential number linked to a specific prep item on a prep list. These are two example ways of generating a unique number for each batch of items prepped at a single time. Accordingly, each batch of prepped food items can be tracked based on the unique number generated and assigned to the batch. Scanned barcodes may be used to link to an original invoice which itemized raw food items. Accordingly, the barcode on a “prep” food safety label may be used to trace food ingredients back to the original food vendor shipment. Thus, the back office (FIG. 1) provides an ability to track centrally where and when an item was purchased or prepared, and to produce a barcode which can be used to link back to that information.

Since back office 10 is centrally-hosted, barcode values assigned and printed at one site may be read and used at other sites. As an example, for food item transfers, the sending site would scan the barcode to “attach” the food item to the transfer. When the receiving site accepts the food item and scans the barcode, they assume responsibility for the food item in inventory. As another example, for commissary or warehouse operations, a central facility may use the “received” labels to track food items through receiving, storage, and shipping to the sites. The site would then scan the food labels upon receiving and accepting the food items, thus maintaining history for each food item.

It should further be apparent that back office 10 (FIG. 1) is a configurable, fully integrated solution providing the function of automated food item labeling and the function of inventory control. The configurable, fully integrated solution enables traceability of food items in inventory. The result of having a configurable, fully integrated solution is total lower cost of ownership.

Although the above description describes a damaged items determination step 230 and a waste items determination step 240 in the flow diagram 200 of FIG. 2, it is conceivable that such determination steps could also occur in the flow diagram 400 of FIG. 4, when raw food items may be found to have expired or to be damaged but not returnable. It is also conceivable that such determinations could occur during physical inventory by checking labels.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A method of operating a back office facility of a restaurant to provide a food safety label for labeling of at least one raw food item received for the restaurant, the method comprising:
receiving delivery of raw food items from a vendor;
converting a purchase order associated with the received raw food items from the vendor to an invoice; and
printing a food safety label based upon quantity of raw food items indicated in the invoice.

2. A method according to claim 1, wherein printing a food safety label includes printing a number of food safety labels each having a line indicating a date on which the raw food items were received from a particular vendor.

3. A method according to claim 1, wherein printing a food safety label includes printing a number of food safety labels each having a line indicating shelf life of the raw food items.

4. A method according to claim 1, wherein printing a food safety label includes printing a number of food safety labels each having a line indicating the day on which the raw food items should be used by.

5. A method according to claim 1, wherein printing a food safety label includes printing a number of food safety labels each having a line indicating that the raw food items should be kept refrigerated.

6. A method according to claim 1, wherein printing a food safety label includes printing a number of food safety labels each having a barcode line which corresponds to the raw food items and indicates a date/time on which the raw food items were received from a particular vendor.

7. A method according to claim 1, wherein the method is performed by a computer having a memory executing one or more programs of instructions which are tangibly embodied in a program storage medium readable by the computer.

8. A method of operating a back office facility of a restaurant to provide a food safety label for labeling of at least one prep food item by the restaurant using raw food items, the method comprising:
creating a forecast of food menu item sales for the restaurant;
translating the forecast of food menu item sales into the quantities of prep items needed for a given time.
printing a prep list which contains a listing of prep food items and their respective prep amounts needed; and
printing a food safety label for each prep food item based upon the prep amount in the prep list.

9. A method according to claim 8, wherein printing a food safety label includes printing a number of food safety labels ahead of time before preparation of the prep food items has been completed.

10. A method according to claim 8, wherein printing a food safety label includes printing a number of food safety labels after preparation of the prep food items has been completed.

11. A method according to claim 8, wherein printing a food safety label includes printing a number of food safety labels each having a line indicating a date and time of day, a particular restaurant employee, and a particular prep station at which a particular prep food item has been prepared.

12. A method according to claim 8, wherein printing a food safety label includes printing a number of food safety labels each having a line indicating the day on which a particular prep food item should be used by, and shelf life of the particular prep food item.

13. A method according to claim 8, wherein printing a food safety label includes printing a number of food safety labels each having a line indicating that a particular prep food item should be kept stored in an airtight container.

14. A method according to claim 8, wherein printing a food safety label includes printing a number of food safety labels each having a barcode line which corresponds to a particular prep food item and indicates the date/time on which the prep food item was prepared.

15. A method according to claim 8, wherein the method is performed by a computer having a memory executing one or more programs of instructions which are tangibly embodied in a program storage medium readable by the computer.

16. A method of operating a back office facility of a restaurant to provide a nutrition facts label for labeling of at least one prep food item by the restaurant using raw food items, the method comprising:
retrieving food ingredients for a prep recipe;
calculating nutritional information for a prep food item using nutrition data associated with the retrieved food ingredients for the prep recipe; and
printing a nutrition facts label based upon quantity of prep food items indicated in the prep recipe.

17. A method according to claim 16, wherein printing a nutrition facts label includes printing a number of nutrition facts labels each having a line indicating a suggested latest date by which the prep food item should be served or sold by.

18. A method according to claim 16, wherein printing a nutrition facts label includes printing a number of nutrition facts labels each having a barcode line which corresponds to the prep food item and indicates the date/time on which the prep food item was prepared.

19. A method according to claim 16, wherein the method is performed by a computer having a memory executing one or more programs of instructions which are tangibly embodied in a program storage medium readable by the computer.
